(19) United States
(12) Patent Application Publication
(10) Pub. No.: US 2025/0136408 A1
(43) Pub. Date: May 1, 2025

(54) ELEVATOR OPERATING UNIT WITH TRAFFIC-DEPENDENT FUNCTIONALITY

(71) Applicant: INVENTIO AG, Hergiswil (CH)

(72) Inventor: Lukas FINSCHI, Ebikon (CH)

(21) Appl. No.: 18/682,826

(22) PCT Filed: Jul. 20, 2022
(86) PCT No.: PCT/EP2022/070358

§ 371 Date: Feb. 9, 2024

(30) Foreign Application Priority Data
Aug. 12, 2021 (EP) 21191042.7

(51) Int. Cl. B66B 1/46; B66B 3/00

(52) U.S. Cl. CPC B66B 1/468; B66B 3/008; B66B 2201/101; B66B 2201/214; B66B 2201/215; B66B 2201/403; B66B 2201/463

(57) ABSTRACT

In an elevator system, floor terminals can be actuated by a control unit in one of at least two operating modes. A screen unit of a floor terminal can generate a user interface with a functional scope dependent on the operating mode. An individual functional scope can be defined for each operating mode. The control unit can determine a local traffic volume at the first floor terminal location. The local traffic volume can be compared with at least one threshold value that is defined for the traffic volume at the first floor terminal to generate a comparison result. A desired operating mode of the first floor terminal can be defined based on the comparison result and the operating mode in which the control unit actuates the first floor terminal. The first floor terminal can be actuated in the defined desired operating mode.

### TECHNICAL FIELD

The present disclosure relates generally to an elevator system having a plurality of elevator operating devices. Embodiments of the disclosure also relate to a method for operating such an elevator system.

### SUMMARY

In order for a passenger to be able to call an elevator, elevator systems are known which either have a floor terminal for entering the desired direction of travel (e.g., “up” and “down” buttons), or a floor terminal for entering the desired destination floor. The latter enable elevator systems with a destination call control system which assigns an elevator call from a passenger to an elevator car in order to transport the passenger to a desired destination floor. An embodiment of an elevator system with a destination call control system is disclosed in document EP 0 443 188 B1; the call allocation is performed by the destination call control system based on calculated operating costs.

EP 3 102 520 B1 describes an elevator system having a destination call control system in which a control unit selects a first or second operating mode according to a traffic situation prevailing in the elevator system. At low traffic, the first operating mode is selected, and the second operating mode is selected at increased traffic. In the first operating mode, an elevator call is immediately assigned, which is entered at a floor terminal on a call entry floor, and the display of the associated elevator at this floor terminal takes place immediately after the call entry. In the second operating mode, the call assignment is delayed, i.e, only shortly before the associated elevator arrives on the call entry floor; either there is no display at the floor terminal, or reference is made to a display panel in the elevator hall.

The aforementioned solutions enable call assignment taking into account the operating situation of the particular elevator system. Interactions between passengers and the elevator system are substantially limited to the call entry. In elevator systems with entry of the desired direction of travel, the call is entered by a first passenger and remains visible at the floor terminal until the arrival of an operating elevator for subsequent passengers on the boarding floor. In elevator systems with entry of the desired destination floor at a floor terminal and subsequent assignment to an elevator car, the entry is made individually by the individual passengers. In certain circumstances, several passengers use the same floor terminal one after the other, which should be done quickly, which is why the options for a passenger to interact with a floor terminal are limited. Depending on the building and its use, however, additional options for interaction can be desired. However, these additional options can lengthen the interaction of a single passenger in such a way that subsequent passengers have to wait until they can use the floor terminal. These delays can not only result in unsatisfactory waiting situations for passengers, but can also lead to a reduction in the transport capacity of the elevator system if the usage time per passenger at the existing floor terminals becomes too long. There is therefore a need for a technology which creates such additional interaction options in an elevator system without having the aforementioned disadvantages.

One aspect of the present disclosure relates to a method for operating an elevator system in a building. The elevator system comprises a number of floor terminals which can be arranged on floors of a building, a control unit communicatively connected to the floor terminals, and an elevator car which can be moved between the floors of the building. In the method, the floor terminals can be actuated by the control unit in one of at least two operating modes, wherein a screen unit of a floor terminal generates a user interface with a functional scope depending on the operating mode; an individual functional scope is defined for each operating mode. A local traffic volume at a location of a first floor terminal can be determined by the control unit which actuates the first floor terminal in one of the at least two operating modes. A local traffic volume can be determined for each floor terminal. The local traffic volume can be compared by the control unit with at least one threshold value which can be defined for the traffic volume at the first floor terminal in order to generate a comparison result. According to the method, a desired operating mode of the first floor terminal may be defined on the basis of the comparison result and the operating mode in which the control unit (8) actuates the first floor terminal. The first floor terminal can then be operated in the defined desired operating mode.

A further aspect of the present disclosure relates to an elevator system which comprises at least one elevator car which can be moved between floors of the building, a control unit and a number of floor terminals which can be arranged on the floors. A floor terminal can have a screen unit which may be designed to generate a user interface. The control unit can be communicatively connected to the floor terminals. The control unit can be designed to actuate the floor terminals in one of at least two operating modes, wherein the screen unit of a floor terminal can generate the user interface with a functional scope that may be dependent on the operating mode. For each operating mode, an individual functional scope can be defined. The control unit can also be designed to determine a local traffic volume at a location of a first floor terminal actuated in one of the at least two modes of operation, and to compare the local traffic volume with at least one threshold value which can be defined for the traffic volume at the first floor terminal in order to generate a comparison result. The control unit can define a desired operating mode of the first floor terminal on the basis of the comparison result and the operating mode according to which the first floor terminal is to be actuated. The first floor terminal can then be operated in the defined desired operating mode.

The disclosure described herein makes it possible for an elevator system to be operable in such a way that additional options for interaction between a passenger and a floor terminal are created without unsatisfactory waiting situations arising for passengers or without reducing the transport capacity of the elevator system. With the disclosure described herein, this can be achieved in that the option of interaction with a floor terminal depends on the local traffic volume at this floor terminal. Depending on the local traffic volume, more or fewer interaction options exist at the floor terminal; corresponding thereto, the functional scope of the operating mode can be generated. For example, if the local traffic volume exceeds a threshold value that is defined for the traffic volume at the floor terminal, this is considered an increased traffic volume, while delays at the (busier) floor terminal are to be avoided. As a result, passengers are offered a reduced functional scope in an effort to minimize the time they spend at the floor terminal.

The reduced functional scope comprises elevator-specific functions, in particular a function for entering elevator calls. These functions are also referred to collectively below as the main functionality. If, on the other hand, the local traffic volume is in the normal range, for example, an extended functional scope can be offered to the passenger, and it comprises the (elevator-specific) main functionality and additionally a service functionality (e.g., information services). With the disclosure described herein, the local traffic volume can therefore be used for actuating the particular floor terminal.

In one embodiment, the floor terminals may be actuated by the control unit in one of two operating modes. In addition, a first threshold value for the traffic volume can be defined at the first floor terminal, wherein the comparison result then displays an increased traffic volume if the local traffic volume is at least equal to the traffic volume defined by the first threshold value. Correspondingly, the same threshold values or ones deviating therefrom can be defined for more or all floor terminals. In addition, in this embodiment, it is defined that the first floor terminal can be actuated in a first operating mode, and the screen unit of the first floor terminal can generate a user interface with a first functional scope. When there is an increased traffic volume indicated by the comparison result, the first floor terminal can be actuated in a second operating mode, wherein the screen unit of the first floor terminal can generate the user interface with a second functional scope in the second operating mode. The second functional scope is less than the first functional scope. With only one threshold value, it can be easily determined whether an increased traffic volume exists at this first floor terminal and in which of the two operating modes the first floor terminal is to be operated.

In one embodiment, both the first functional scope and the second functional scope comprise a function for entering elevator calls. The call can therefore be entered in each of the operating modes.

In one embodiment, the first functional scope comprises a first main functionality and a service functionality; the second functional scope, in contrast, comprises exclusively a second main functionality. The first main functionality can be the same as the second main functionality. In this case, the same main functionality can be offered to the passenger independent of the local traffic volume in the two operating modes. In one embodiment, the first main functionality can be different from the second main functionality. In this case, depending on the local traffic volume, different main functionalities can be offered to the passenger, and one or more substantially identical functions can be present in both main functionalities. As a result, for example, with increased local traffic volume, the possibility of interaction can be further reduced, and not only because the display of the service functionality is omitted.

In one embodiment, both the first functional scope and the second functional scope each comprise the call entry fields associated with the floors, and the first functional scope comprises information fields associated with individual services. These information fields are not comprised by the second functional scope. The call entry fields and the information fields can be displayed on the user interface of a floor terminal. The passengers are usually familiar with this type of display on a user interface so that operation is basically self-explanatory.

It is usually also apparent for the passengers which fields, when touched, perform a service associated with the field. For example, if a passenger touches an information field, a service that is associated with the touched information field can be executed. The screen unit of the relevant floor terminal then actuates the user interface to display the selected service.

The services available for selection can be flexibly defined for a building. In one embodiment, the services comprise a weather information service, an elevator information service, a user setting service, a building information service, a shopping and/or entertainment service and/or a news service. In an office building, the message service can comprise, for example, current business news. Additional examples of such services are described throughout this description.

In one embodiment, the call entry fields and/or the information fields can be displayed dynamically on the basis of a time parameter. The time parameter can specify a month, a day of the week, a time of day, and/or a season. As a result, for example, the number of information fields and/or the services associated with them can vary depending on the day of the week.

If a passenger touches a call entry field of the first floor terminal, the control unit registers an elevator call for a trip from the floor on which the passenger is located to the floor associated with the call entry field. In one embodiment, an elevator car (or an elevator) can be directly associated with this elevator call for call operation. The control unit actuates the screen unit of the first floor terminal for directly displaying the associated elevator car on the user interface. The direct display of the associated elevator car can be independent of whether or not an increased local traffic volume exists.

In one embodiment, the user interface generated by the screen unit of the first floor terminal can depend not only on the functional scope dependent on the operating mode, but also on the location of the first floor terminal. The user interface can therefore be specifically configured for the location of the first floor terminal in each operating mode.

In another embodiment, a third operating mode for which a second threshold value for the general traffic volume is defined in the elevator system can be defined for actuating the floor terminals by the control unit. If the general traffic volume is at least equal to the traffic volume defined by the second threshold value, a comparison result can indicate a capacity full load of the elevator system. The first floor terminal can then be actuated in the third operating mode, and the screen unit of the first floor terminal can generate a user interface with a third functional scope. The third functional scope comprises information regarding the capacity full load of the elevator system. The information can inform passengers, for example, that no calls can be registered at the moment or that long waiting times are to be expected. In one embodiment, the information can comprise alternative proposals, e.g., an estimated waiting time and/or other routes (possibly by stairways and/or other elevators). The passengers therefore remain informed even in such operating situations.

With the disclosure described herein, the local traffic volume can be determined at the first floor terminal (or at multiple or at all floor terminals). For this purpose, in one embodiment, elevator calls which are entered at the first floor terminal within a defined period of time and registered by the control unit can be evaluated. This information is available in the control unit so that the control unit can be configured (e.g., programmed) for this purpose without major effort.

In another embodiment, a sensor system installed in the building can be used which is communicatively connected to the control unit. In order to determine the local traffic volume, sensor signals which are generated by the sensor system are evaluated. Depending on the embodiment, the sensor system can not only detect a passenger during the (actual) call entry at the first floor terminal, but also passengers who may stop in the surroundings of the first floor terminal and, under certain circumstances, then wish to enter an elevator call.

In another embodiment, a stored traffic pattern can be used to determine the local traffic volume. The traffic pattern can be determined from data relating to previous local traffic volume as a function of time. In order to determine the local traffic volume at a specific time (e.g., month, day, time), the traffic volume can be used which has passed beforehand at a corresponding time. In this embodiment, the control unit can also be correspondingly designed (e.g., programmed) without major effort.

### BRIEF DESCRIPTION OF THE DRAWINGS

Various aspects of the disclosure are described in greater detail herein in conjunction with the drawings with reference to exemplary embodiments. In the figures, identical elements have identical reference signs. In the drawings:

FIG. 1 shows a schematic representation of an embodiment of an elevator system in a building having multiple floors,

FIG. 2 shows a schematic representation of elevator groups of the elevator system;

FIG. 3 shows a schematic representation of an embodiment of a user interface of a floor terminal according to a first operating mode;

FIG. 4 shows a schematic representation of an embodiment of a user interface of a floor terminal according to a second operating mode;

FIG. 5 shows a schematic representation of an embodiment of a display of an associated elevator on the user interface of a floor terminal; and

FIG. 6 shows an exemplary representation of an embodiment of a method for actuating a floor terminal using a schematic flowchart.

### DETAILED DESCRIPTION

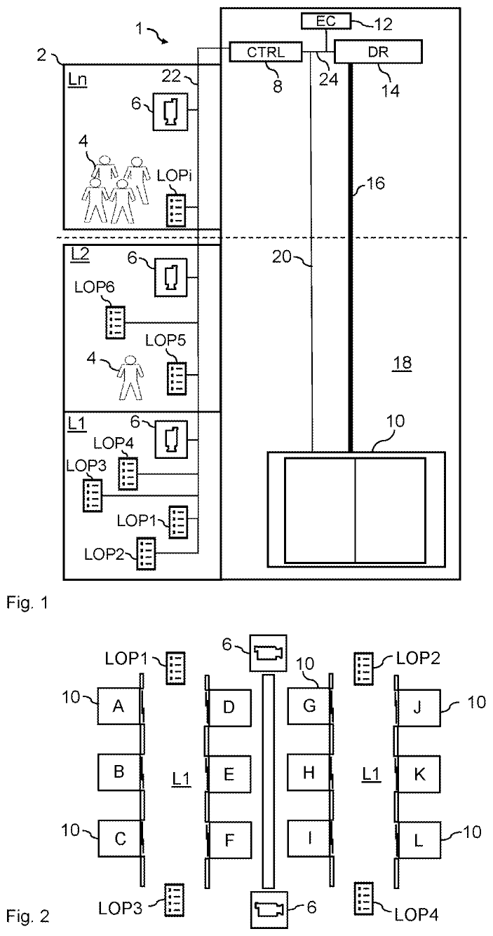

FIG. 1 shows a schematic representation of an embodiment of an elevator system 1 in a building 2; the building 2 can in principle be any type of multi-story building (e.g., residential building, hotel, office building, sports stadium, etc.). Components and functions of the elevator system 1 are explained below, insofar as they appear helpful for understanding the disclosure described herein. The building 2 shown in FIG. 1 has multiple floors L1, L2, Ln (n=floor number) on which elevator operating devices LOPi (referred to below as floor terminals LOPi), wherein i=1, 2, 3, 4, 5, 6 . . . m, and m=number of floor terminals LOPi). The floors L1, L2, Ln are served by the elevator system 1, e.g., a passenger 4 can enter an elevator call at a floor terminal LOPi in order to then be conveyed from a call entry floor to a destination floor by the elevator system 1. The call entry floor is also referred to as a boarding floor.

In the exemplary embodiment shown in FIG. 1, the elevator system 1 has an elevator car 10 that can be moved in an elevator shaft 18 and is connected by a support means 16 (cables or belts) to a drive unit (DR) 14 and is suspended on this drive unit 14. In this case it can be a traction elevator, wherein further details, such as a counterweight and guide rails, for example, are not shown in FIG. 1. The elevator controller (EC) 12 is connected to the drive unit 14 and actuates the drive unit 14 in order to move the elevator car 10 in the shaft 18. The operation of a traction elevator, its components and the tasks of an elevator control system 12 are generally known to a person skilled in the art. In another embodiment, the elevator system 1 can comprise a hydraulic elevator. A person skilled in the art also understands that the elevator system 1 can comprise multiple cabins, or one or more groups of elevators.

The elevator system 1 shown in FIG. 1 is equipped with a destination call control system, the functionality of which in the shown embodiment is shown by a control unit (CTRL) 8. In this description, the designation “destination call control system” is understood to mean the components (e.g., computers, processors, memory devices) and associated control and computer programs which execute the functions described below and/or are involved in their execution. The control unit 8 is representative of these components and control and computer programs shown in FIG. 1.

In one embodiment, the control unit 8 or its functionality can be implemented completely or partially in the elevator controller 12. If the elevator system 1 comprises one or more groups of elevators, the functionality of the destination call control system can be implemented completely or partially in a group controller. The functionality of the destination call control system can also be implemented in combination with the floor terminals LOPi. The destination call control system assigns one of several elevator cars 10 present in the elevator system 1 to an elevator call (destination call) of a passenger 4 entered at a floor terminal LOPi, and communicates the corresponding assignment information via a communication bus 24 to the elevator controller 12 and via a communication bus 22 to the floor terminal LOPi at which the passenger 4 is located when the call is entered. Further details regarding the functionality of the control unit 8 and its function in conjunction with a destination call control system are specified elsewhere in this description.

For illustration purposes, FIG. 1 shows four floor terminals LOP1-LOP4 on the floor L1, two floor terminals LOP5, LOP6 on the floor L2, and a single floor terminal LOPi on the floor Ln. A person skilled in the art understands that the number of floor terminals LOPi arranged on a floor L1, L2, Ln can be defined on the basis of the elevator system 1 and building 2. FIG. 2 shows for example an arrangement of twelve elevators (elevator cars 10) such as may exist on the floor L1, for example. The elevators are organized into two elevator groups of six elevators each (elevators A-F and elevators G-L), and the passengers 4 have access to each elevator group on two sides. In the shown embodiment, a floor terminal LOP1-LOP4 is arranged at each access. A person skilled in the art understands that the elevator groups, the accesses, and the floor terminals LOP1-LOP4 can be arranged in a different manner. A person skilled in the art also understands that access to the elevator groups can be controlled in conjunction with the floor terminals LOP1-LOP4.

At one of the floor terminals LOPi, a passenger 4 can enter a desired destination floor. According to one embodiment, each floor terminal LOPi comprises a display device (also referred to below as a touchscreen) with a touch-sensitive screen, the fields associated with destination floors, and/or identifiers. The mode of operation and structure of a touchscreen are generally known to a person skilled in the art, in particular a person skilled in the art knows, for example from the programming and use of smartphones, how symbols, pictograms, entry and output fields etc. are generated on a touchscreen and displayed on a user interface. It is also known to a person skilled in the art that the components of the floor terminal LOPi can be arranged, for example, in a housing so that the floor terminal LOPi can be arranged at a desired location on a floor L1, L2, Ln.

In the building 2 with an elevator system 1, as shown in FIG. 1 and FIG. 2, for example, the technology described here can be used in an advantageous manner in order to operate the elevator system 1 with as much transport capacity as possible and the best possible comfort for the passengers 4. Summarized briefly and by way of example, the elevator system 1 in one embodiment is operated as follows: The control unit 8 registers a traffic volume prevailing in the building 2, which can move within the usual or a predefined framework, but can also be higher or lower. For this purpose, the control unit 8 can evaluate, for example, the elevator call entries per unit of time, sensor signals generated by a sensor system, and/or use a traffic pattern generated from historical usage data. Furthermore, the control unit 8 is designed to determine a local traffic volume which prevails (locally) at a specific floor terminal LOPi; this floor terminal LOPi is referred to below as the first floor terminal LOPi and is representative of the technology described here. In a reception hall of a hotel, for example, after arrival of a tour group, the traffic volume is generally higher there; in particular, the traffic volume can, for example, be higher at a floor terminal LOP1 (FIG. 2) which is arranged closer to reception desk than at a floor terminal LOP4 (FIG. 2) which is arranged further away therefrom.

According to the disclosure described herein, the control unit 8 actuates this (first) floor terminal LOPi on the basis of the local traffic volume. In the case of low local traffic volume, the floor terminal LOPi is actuated according to a first operating mode in which the user interface displays an expanded screen content or a first screen content with a first (expanded) functional scope; it comprises an (elevator-specific) main functionality and a service functionality (e.g., information services). A passenger 4 can, for example, leave time for viewing or reading the information services (e.g., before or after a call entry) without impeding the call entry of other passengers 4. In the event of increased local traffic volume, the floor terminal LOPi is actuated according to a second operating mode in which the user interface displays a second (reduced) screen content with a second functional scope. The first functional scope is different from the second functional scope. The reduced functional scope comprises substantially only the aforementioned main functionality. In one embodiment, the main functionality enables an entry of a destination floor, wherein only elevator-specific functions are displayed (e.g., “buttons” for destination floors). This allows the passenger 4 to free up the floor terminal LOPi as quickly as possible for a subsequent passenger 4 after entering the call and reading the assigned elevator.

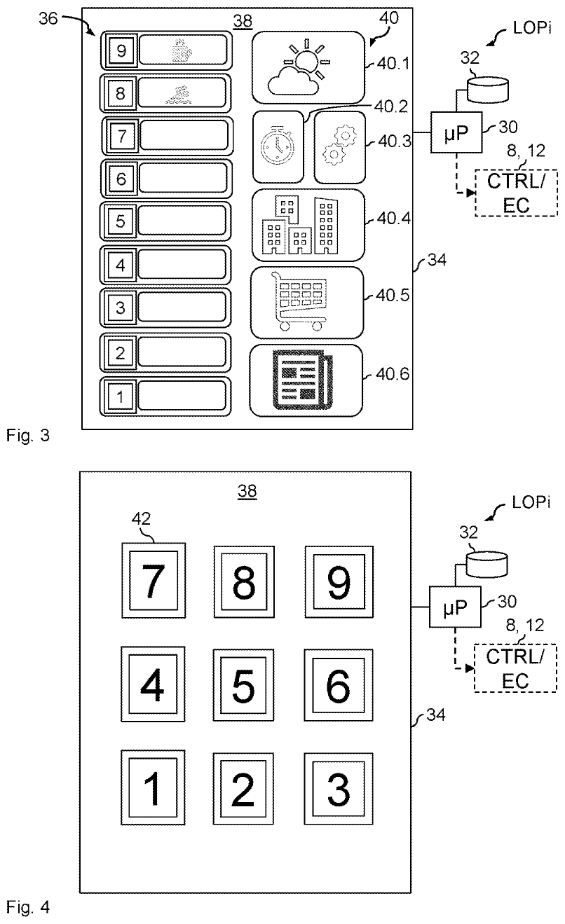

FIG. 3 and FIG. 4 show exemplary user interfaces with different functional scopes (screen contents). FIG. 3 shows a schematic representation of an embodiment of a floor terminal LOPi which has a processing device 30 (UP), a memory device 32, and a display device 34. As explained above, the display device 34 comprises a touchscreen. In one embodiment, the memory device 32 stores a computer program which runs the processing device 30 during operation. The processing device 30 actuates the display device 34, as described in the following; it is also communicatively connected to the elevator controller 12 which is shown with dashed lines in FIG. 3 and in FIG. 4 for the sake of illustration. Actuated by the control unit 8, the processing device 30 actuates the display device 34 in one of at least two operating modes such that, depending on the prevailing traffic volume, it generates a user interface 38 with a functional scope that is dependent on the operating mode. By means of this user interface 38, a passenger 4 can, for example, enter an elevator call and obtain information about made and confirmed calls. In addition to this user interface 38, the floor terminal LOPi has, in one embodiment, a loudspeaker (not shown) for outputting acoustic messages.

In the exemplary embodiment shown in FIG. 3, the user interface 38 shows a first functional scope according to the first operating mode. The first functional scope comprises a first main functionality and a service functionality.

The exemplary user interface 38 shows a plurality of fields 36, 40. The main functionality comprises the fields 36 which are arranged in a column and associated with floors. The fields 36 can, for example, be numbered (e.g., floors 1-9), labeled (e.g., with names) and/or marked with symbols/pictograms (e.g., the floors 8, 9). If a passenger 4 touches one of the fields 36, a destination call to the floor associated with the field 36 is registered. The fields 36 can also be referred to as call entry fields 36.

The service functionality comprises the fields 40 which are likewise arranged in a column in the shown embodiment. Each (information) field 40 can be associated with at least one functionality or a service: one information field 40.1 is provided for weather information (weather information service 40.1), one information field 40.2 for elevator information (e.g., arrival time of the associated elevator, operating and fault information) (elevator information service 40.2), one information field 40.3 for user settings (e.g., settings of a passenger 4 that can be made on-site, e.g., preferred destination floors and/or choice or change of a PIN code) (user settings service 40.3), one information field 40.4 for building information (e.g., a building plan) (building information service 40.4), one information field 40.5 for shopping and/or entertainment options (shopping and/or entertainment service 40.5), and one information field 40.6 for news (news service 40.6). Depending on the design of the floor terminal LOPi, the passenger 4 can touch one of these fields 40 in order to have additional information associated with the field 40 displayed.

A person skilled in the art understands that the arrangement, the classification, and the number of fields 36, 40 are exemplary and that the fields 36, 40 can be arranged in a different manner. In addition, a person skilled in the art understands that the design of the fields 36, 40 (e.g., size, shape, black/white, color, etc.) can be coordinated with the floor terminal LOPi (e.g., size of the display device 34) and the building 2.

FIG. 4 shows an exemplary user interface 38 with a second functional

scope according to the second operating mode. The second functional scope comprises a second main functionality; a service functionality (analogous to that in FIG. 3) is not displayed here. The exemplary user interface 38 shows fields 42 that are associated with the floors used by the elevator system 1; these (call entry) fields 42 can, for example, be numbered (e.g., floors 1-9 as shown in FIG. 4) and/or marked with symbols/pictograms. If a passenger touches one of the fields 42, a destination call is registered on the floor associated with the field 42. In the shown embodiment, the fields 42 are arranged in a matrix; the fields 42 can also be arranged in a different manner (as in connection with FIG. 3) which also applies to their design (e.g., size, shape, black/white, color, etc.).

The exemplary embodiments of FIG. 3 and FIG. 4 show that an individual functional scope is defined for each operating mode. In these exemplary embodiments, the second functional scope is less than the first functional scope. In FIG. 3, the first main functionality indicates, by way of example, the numbered and marked call entry fields 36, whereas in FIG. 4, the second main functionality only displays the numbered call entry fields 42 by way of example. In these exemplary embodiments, the first main functionality is different from the second main functionality (e.g., with respect to functional scope and manner of representation). In another embodiment, the first main functionality can be the same as the second main functionality.

A person skilled in the art understands that further operating modes can be used in addition to the first and second operating modes, depending on the determined (local) traffic volume. A plurality of operating modes can therefore be associated with a plurality of traffic volumes, for example with a decreasing functionality of an operating mode with increasing traffic volume.

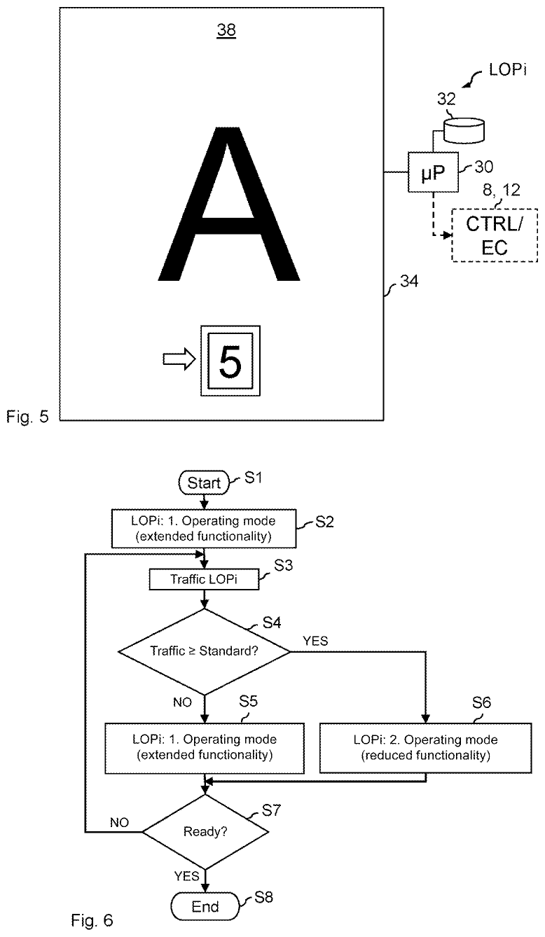

The screen content displayed in FIG. 3 and FIG. 4 can change when operated by a passenger 4, for example for a set period of time. If the passenger 4 touches one of the fields 36 (FIG. 3) or one of the fields 42 (FIG. 4), to enter a call (destination call) for a trip from the boarding floor to a desired destination floor, the floor terminal LOPi-controlled by the processing device 30-displays, for example, a designation of the elevator (e.g., “A”), which is associated with the elevator call, and the selected destination floor (e.g., “5”) on the user interface 38, as is shown by way of example in FIG. 5. In one embodiment, the assignment and display of the designation of the associated elevator takes place immediately after the call entry. The elevator designation can, for example, be displayed for 1-2 seconds.

A person skilled in the art understands that touching one of the (information) fields 40 shown in FIG. 3 also has the result that the screen content changes from a default setting to a temporary setting. In the temporary setting, the additional information associated with the touched field 40 can be displayed within this field 40. In one embodiment, the field 40 can also be displayed enlarged after being touched; for example, it can cover one or more untouched fields 40. An untouched field 40 can also be (temporarily) not displayed. In one embodiment, a duration can be defined for the temporary setting; after this duration has elapsed, the screen content is displayed again in the default setting. Both the duration and the information content of the displayed screen content can depend on the (first or second) operating mode. In the first operating mode, the duration can be longer and/or the information content can be richer, or passengers 4 can be offered further interaction options. In the second operating mode, the duration can be shorter and/or the information content less without further interaction options.

Furthermore, the interaction options can be displayed or not displayed depending not only on the operating mode; if an operating mode provides for an interaction option, this can also mean that this is possible in the relevant operating mode, but is only displayed if other conditions are met (e.g., based on the location of the floor terminal, the time of day, the day of the week, settings of the building operator or the elevator user or usage information of the same, data from sensors in the building or external data sources). In the first operating mode, the arrangement, the categorization, and/or the number of fields 36, 40 can vary in one embodiment, for example the information field 40.5 for shopping and/or entertainment options can only be displayed during the opening times thereof, and the weather information (information field 40.1) is displayed only in the morning; it can alternatively or additionally vary locally, i.e, depending on the location of the floor terminal LOPi. Similarly, the content of the fields 36, 40 can be displayed adapted to the time and/or location.

The control unit 8 in the elevator system 1 according to FIG. 1 represents the functionality of a destination call control system. The basic function of a destination call control and the call allocation performed by it are known, for example from the book by G. C. Barney et al., Elevator Traffic Analysis Design and Control, Rev. 2nd Ed., 1985, pp. 135-147, or the above-mentioned patent document EP 0 443 188 B1. This patent document describes, for example, that a computer knows the load, the position and the operating status of an elevator car, the operating status of a drive, and has additional information about the current and previous traffic volume for each elevator of the elevator system at any time. Based on this information, the destination call allocation algorithm described there allocates newly entered destination calls to the elevators as optimally as possible according to predefined criteria (e.g., wait time until arrival at the call entry floor). The basis of the destination call allocation are calculations of the operating costs. The individual calculated operating costs are compared call by call, and the elevator with the lowest operating costs is selected to serve the destination call.

In one embodiment, the control unit 8 evaluates predefined information about traffic volume. The control unit 8 can, for example, be present centrally for the elevator system 1, or decentralized for individual elevators or individual floor terminals LOPi. The control unit 8 is designed (e.g., by means of an executable computer program) to evaluate the number of entered elevator calls as a function of the time and the floor L1, L2, Ln or also the floor terminals LOPi. An instantaneous traffic volume can thereby be determined for each floor L1, L2, Ln, for example. The control unit 8 is also designed to carry out a corresponding evaluation relative to a single floor terminal LOPi. Such an evaluation can be carried out for one, more or all floor terminals LOPi. In addition to the mentioned floor-specific evaluation, the instantaneous traffic volume can thereby be determined at a single floor terminal LOPi. If multiple floor terminals LOPi are arranged on a floor L1, L2, Ln, the (local) traffic volume can be determined at the location of the particular floor terminal LOPi. In the above-mentioned example of the arrival of a tour group, an instantaneous traffic volume is determined at the floor terminal LOP1, for example, and compared with predefined information about traffic volume, whereby an operating mode for an increased traffic volume can be selected.

In one embodiment, the control unit 8 stores the data of the determined traffic volume as a function of the time and the location (floor, location) in a memory device. The memory device can be an internal data memory of the control unit 8 or an external memory device which is communicatively connected to the control unit 8. From the stored data, it can be determined which traffic volume existed in the past at which locations at which times (e.g., year, month, weekday, time, season). Average values can be determined therefrom as a function of the time and the location, among other things a traffic pattern which is used in one embodiment in order to establish a normal framework for the traffic volume for a floor terminal LOPi. Based on this, it can be determined during operation whether the current traffic volume is higher or lower. In one embodiment, it can be sufficient to recognize that the traffic volume is higher than this in order to then switch to the second operating mode. In this case, the screen content shown in FIG. 3 changes to the screen content shown in FIG. 4. The second operating mode remains until the traffic volume is again within the usual framework.

In one embodiment, the elevator system 1 comprises a sensor system 6. The sensor system 6 is optional; it can be used, for example, together with the destination call control system to determine the traffic volume. In another embodiment, it can be used basically independently of the destination call control system to determine the traffic volume. Both in FIG. 1 and also in FIG. 2, the optional sensor system 6 is shown for illustration purposes. FIG. 1 shows individual camera devices of the sensor system 6 arranged on the floors L1, L2, Ln, which are connected to the control device 8 via the communication bus 22, for example. Each camera device is assigned a spatial detection area, and each camera device is arranged such that its spatial detection area comprises a floor terminal LOPi and/or its spatial environment, wherein the detection area of a camera device can also comprise more than one floor terminal LOPi (and the corresponding spatial environments). In one embodiment, a camera device can be arranged above a floor terminal LOPi, e.g., on a building ceiling.

The sensor system 6 comprises an image processing device that evaluates images generated by the camera devices (e.g., video recordings, individual images). The aim of evaluating the image(s) from one of the camera devices is to detect the presence of a passenger 4 within the detection area and, if several passengers 4 are present there, to determine the number of passengers 4. In one embodiment, the camera devices can be designed, for example, for taking images in the visible optical spectrum or in the infrared range; the camera devices can comprise 3D cameras which are based, for example, on the principle of time of flight measurement (TOF sensor). Details regarding this measuring principle are specified, for example, in R. Jeremias et al. “A CMOS Photosensor Array for 3D Imaging Using Pulsed Laser”, 2001 IEEE International Solid-State Circuits Conference, page 252. Objects (passengers 4) can be detected with such a 3D camera and their number, positions and movement directions can be determined. For such an evaluation, a computer program is installed in the image processing device; such computer programs for image processing or image evaluation are known to a person skilled in the art.

According to one embodiment, the sensor system 6 detects for each floor L1, L2, Ln the passengers 4 that are located there. In one embodiment, the traffic volume there can therefore be determined for each floor L1, L2, Ln. Depending on the design of the sensor system 6 and/or the arrangement of the individual camera devices, in one embodiment, the traffic volume can be determined per floor terminal LOPi, i.e, a local traffic volume in each case.

With an understanding of the basic structure and function of the elevator system 1 described in connection with FIG. 1-FIG. 5, a description of an embodiment of a method for operating the elevator system 1, in particular a method for operating the floor terminals LOPi, is given herein with reference to FIG. 6. FIG. 6 shows an exemplary flowchart of a method for operating the elevator system 1. The method according to FIG. 6 begins with a step S1 and ends with a step S8.

In a step S2, the floor terminals LOPi are actuated by the control unit 8 in one of at least two operating modes. The screen unit 34 of one of these floor terminals LOPi generates a user interface 38 with a functional scope depending on the operating mode, wherein an individual functional scope is defined for each operating mode. In the embodiment according to FIG. 6, a (first) floor terminal LOPi considered as an example for this description is actuated by the control unit 8 according to a first operating mode; this is an example of an assumed initial situation. In the first operating mode, the user interface 38 displays an extended functional scope. The extended functionality comprises the main functionality and the service functionality.

In a step S3, a local traffic volume is determined at a location of the first floor terminal LOPi by the control unit 8 which actuates the first floor terminal LOPi in one of the at least two operating modes. The actuation takes place in FIG. 6 according to the first operating mode. The local traffic volume can be determined by means of one of the above-mentioned procedures.

In a step S4, the local traffic volume determined in step S3 is compared with at least one threshold value which is defined for the traffic volume at the relevant or first floor terminal LOPi, by the control device 8 in order to generate a comparison result. In the embodiment in FIG. 6, the local traffic volume is compared with a threshold value (standard). If the comparison result reveals that the local traffic volume is greater than or equal to the threshold value, the method proceeds along the yes branch to a step S6; if in contrast this is not the case, the method proceeds along the no branch to a step S5.

In the steps of S5 and S6, a desired operating mode of the first floor terminal LOPi is defined on the basis of the comparison result and the operating mode in which the control unit 8 actuates the first floor terminal LOPi. In the embodiment shown in FIG. 6, the first floor terminal LOPi is actuated in the first operating mode (initial situation, see step S2). If the local traffic volume is less than the threshold value (no branch from step S4), no change of the operating mode is required, and the first operating mode is retained or redefined in step S5. The first floor terminal LOPi is operated according to the defined first operating mode, wherein the extended functionality is still displayed. However, a change of the operating mode occurs if the local traffic volume is greater than or equal to the threshold value (yes branch from step S4). In step S6, the second operating mode is then defined as the desired operating mode, and the first operating mode (initial situation, see step S2) is changed to the second operating mode. The first floor terminal LOPi is operated according to the defined second operating mode, wherein the reduced functionality is displayed.

At certain times, very few passengers can be in the building, and/or very few or no travel requests can exist (e.g., at night or at the weekend). At these times, the elevator system 1 can be switched to a standby mode (standby), in which, among other things, the floor terminals are switched to an energy-saving mode; their screen units 34 are then deactivated and do not display a user interface 38. This is shown in a step S7; as long as the elevator system 1 is not in standby mode, the method returns along the no branch to step S3. If, on the other hand, the elevator system 1 is in standby mode, the method proceeds along the yes branch and ends in step S8.

1-15. (canceled)

16. A method for operating an elevator system in a building, wherein the elevator system comprises: a number of floor terminals which are positioned on floors of the building, a control unit communicatively connected to the floor terminals, and an elevator car configured to move between the floors of the building, the method comprising:
actuating the floor terminals by the control unit in one of at least two operating modes, wherein a screen unit of each floor terminal generates a user interface with a functional scope dependent on the operating mode, and wherein an individual functional scope is defined for each operating mode,
determining a local traffic volume at a location of a first floor terminal by the control unit which actuates the first floor terminal in one of the at least two operating modes;
comparing the local traffic volume with at least one threshold value that is defined for the traffic volume at the first floor terminal, by the control unit in order to generate a comparison result,
defining a desired operating mode of the first floor terminal on the basis of the comparison result and the operating mode in which the control unit actuates the first floor terminal; and
operating the first floor terminal in the defined desired operating mode.

17. The method of claim 16, wherein the floor terminals are actuated by the control unit in one of two operating modes, in which a first threshold value for the traffic volume is defined at the first floor terminal, and in which the comparison result indicates an increased traffic volume when the local traffic volume is at least equal to the traffic volume defined by the first threshold value,
wherein the first floor terminal is actuated in a first operating mode, and the screen unit of the first floor terminal generates a user interface with a first functional scope, and
wherein the first floor terminal is actuated in a second operating mode in the event of an increased traffic volume indicated by the comparison result, wherein the display device of the second floor terminal generates the user interface with a second functional scope in the second operating mode, wherein the second functional scope is less than the first functional scope.

18. The method of claim 17, wherein both the first functional scope and the second functional scope comprise a function for entering elevator calls.

19. The method of claim 18, wherein both the first functional scope and the second functional scope each comprise call entry fields assigned to the floors, and wherein only the first functional scope comprises information fields assigned to individual services, wherein the call entry fields and the information fields can be displayed on the user interface of a floor terminal.

20. The method of claim 19, further comprising detecting a touching of an information field by a passenger and executing a service that is associated with the touched information field, wherein the screen unit of the relevant floor terminal actuates the user interface to display the selected service.

21. The method of claim 19, wherein the services comprise at least one of a weather information service, an elevator information service, a user setting service, a building information service, a shopping or entertainment service, a news service.

22. The method of claim 19, further comprising detecting a touching of a call entry field when an elevator call is entered by a passenger, registering the elevator call for a trip to the floor associated with the call entry field by the control unit, directly assigning the elevator call to the elevator car by the control unit, and actuating the screen unit of the first floor terminal for directly displaying the associated elevator car on the user interface.

23. The method of claim 16, wherein the user interface generated by the screen unit of the first floor terminal with the functional scope depending on the operating mode is further generated depending on the location of the first floor terminal.

24. The method of claim 19, wherein at least one of the call entry fields or the information fields are displayed dynamically as a function of a time parameter, wherein the time parameter specifies in particular at least one of one month, one weekday, one time of day, or one season.

25. The method of claim 17, wherein, in order to actuate the floor terminals by the control unit, a third operating mode is defined in which a second threshold value for a general traffic volume in the elevator system is defined, and wherein the comparison result indicates a full load of the elevator system when the local traffic volume is at least equal to the traffic volume defined by the second threshold value, wherein the first floor terminal is actuated in the third operating mode, and the screen unit of the first floor terminal generates a user interface with a third functional scope, wherein the third functional scope comprises information on the full load of the elevator system.

26. The method of claim 16, wherein elevator calls which are registered by the control unit are evaluated in order to determine the local traffic volume, wherein elevator calls which are entered at the first floor device are used in particular for the evaluation.

27. The method of claim 16, wherein sensor signals that are generated by a sensor system installed in the building that is communicatively connected to the control unit are evaluated in order to determine the local traffic volume.

28. The method of claim 16, wherein a stored traffic pattern is used to determine the local traffic volume, wherein the traffic pattern is determined from data on previous local traffic volumes as a function of time.

29. An elevator system in a building, comprising:
at least one elevator car that can be moved between floors of a building;
a number of floor terminals that are arranged on the floors, wherein each floor terminal has a screen unit which is configured to generate a user interface; and
a control unit communicatively connected to the floor terminals, wherein the control unit is configured to:
control the floor terminals in one of at least two operating modes, wherein the screen unit of each floor terminal generates the user interface with a functional scope dependent on the operating mode, wherein an individual functional scope is defined for each operating mode,
determine a local traffic volume at a location of a first floor terminal actuated in one of the at least two operating modes,
compare the local traffic volume with at least one threshold value that is defined for the traffic volume at the first floor terminal in order to generate a comparison result;
define a desired operating mode of the first floor terminal on the basis of the comparison result and the operating mode in which the first floor terminal is to be actuated, and
operate the first floor terminal in the defined desired operating mode.

30. The elevator system according to claim 29 further comprising a sensor system communicatively connected to the control unit configured to generate sensor signals which are evaluated by the control unit for determining the local traffic volume, wherein the control unit is configured to evaluate registered elevator calls in order to determine the traffic volume, in particular a local traffic volume, and wherein the control unit is configured to use a stored traffic pattern to determine a local traffic pattern, wherein the local traffic pattern is determined from data on previous local traffic results as a function of time.

31. The method of claim 20, wherein the services comprise at least one of a weather information service, an elevator information service, a user setting service, a building information service, a shopping and/or entertainment service, a news service.

32. The method of claim 20, further comprising detecting a touching of a call entry field when an elevator call is entered by a passenger, registering the elevator call for a trip to the floor associated with the call entry field by the control unit, directly assigning the elevator call to the elevator car by the control unit, and actuating the screen unit of the first floor terminal for directly displaying the associated elevator car on the user interface.

33. The method of claim 20, wherein the user interface generated by the screen unit of the first floor terminal with the functional scope depending on the operating mode is further generated depending on the location of the first floor terminal.

34. The method of claim 22, wherein the user interface generated by the screen unit of the first floor terminal with the functional scope depending on the operating mode is further generated depending on the location of the first floor terminal.

35. The method of claim 20, wherein, in order to actuate the floor terminals by the control unit, a third operating mode is defined in which a second threshold value for a general traffic volume in the elevator system is defined, and wherein the comparison result indicates a full load of the elevator system when the local traffic volume is at least equal to the traffic volume defined by the second threshold value, wherein the first floor terminal is actuated in the third operating mode, and the screen unit of the first floor terminal generates a user interface with a third functional scope, wherein the third functional scope comprises information on the full load of the elevator system.
